(19) United States
(12) Patent Application Publication
(10) Pub. No.: US 2017/0202138 A1
(43) Pub. Date: Jul. 20, 2017

(54) WHEELED LAWNMOWER FOR WALKING DRIVER

(71) Applicant: PELLENC (Societe Anonyme), Pertuis (FR)

(72) Inventor: Roger PELLENC, Pertuis (FR)

(21) Appl. No.: 15/324,821

(22) PCT Filed: Aug. 25, 2015
(86) PCT No.: PCT/FR2015/052262

§ 371 Date: Jan. 9, 2017

(30) Foreign Application Priority Data
Sep. 15, 2014 (FR) 1458650

(51) Int. Cl. A01D 34/69; A01D 34/71; A01D 34/74; A01D 34/82; A01D 34/78; A01D 34/81

(52) U.S. Cl. CPC A01D 34/69; A01D 34/78; A01D 34/81; A01D 34/74; A01D 34/824; A01D 34/71; A01D 2101/00

(57) ABSTRACT

A lawnmower includes a chassis with a rear portion provided with rear wheels having a stationary axis of rotation (R) and a front portion provided with at least one pivoting front wheel, a motorised cutting unit rigidly connected to the chassis, and a handlebar. The handlebar is mounted on at least one rear rigid extension of the rear portion of the chassis, hinged about a hinging axis (G) parallel to the axis of rotation of the rear wheels between at least one operating position and a maintenance position in which the handlebar is folded towards the front portion of the chassis, and the front portion of the chassis is provided with a lock for locking the handlebar in the maintenance position.

### TECHNICAL FIELD

The present invention concerns a wheeled landscaping mower for walk-behind operator, such as a lawn mower or a mower-brush-cutter. A wheeled lawn-mower for a walk-behind operator means a mower that is pushed or self-propelled that is neither meant to be carried by the user, nor intended to carry the user. The user of the mower walks behind the mower during the mowing or brush-cutting operation. The invention finds applications especially in the field of professional mowing for the maintenance of green spaces or for brush-cutting. It finds applications also among private users for the upkeep of lawns.

### STATE OF PRIOR ART

Mowers for walk-behind operators present in general a cutting unit maintained at a predetermined distance from the ground by wheels or rollers. The wheels are generally attached to a cutter casing and are height-adjustable in order to establish a distance between the cutter housing and the ground. This distance determines also the cutting height of the grass or woody plants.

The mowers are also equipped with a handlebar which the operator grasps to push and/or direct the mower.

The handlebar is generally provided with controls, such as for example an engine starting control in the case of a combustion engine, for a mower forward speed, a stop control for the cutting blades, a blade brake control or a gear-changing control.

Walk-behind mowers present a certain number of advantages, and especially great flexibility in their utilization. They particularly present the advantage of relative compactness which is convenient for the maintenance of urban green spaces or small areas.

On the other hand, the handlebar constitutes the major limit to compactness. Of course, there are models with folding handlebars but the space requirement for the handlebar remains an obstacle for the storage of mowers or for the transportation to the work area. In its folded position, it usually exceeds the ground space taken up by the mower chassis. When the mower is transported in the trunk of a vehicle or in a truck, it moves around in that space when in motion which leads to repeated shocks to the portion of the handlebar extending over the ground space occupied by the mower.

Another difficulty encountered with walk-behind mowers relates to the accessibility of the cutting elements, particularly the casing and the cutting blades for maintenance or cleaning operations.

Utilization of mowers for cutting plants and in particular wet herbaceous plants can result in the cutting elements becoming clogged. Of course, such clogging makes cleaning operations necessary. Furthermore, when the blades hit obstacles such as small stones during the mowing, the sharpened side of the blade becomes dull.

Therefore, regular maintenance and sharpening operations of the cutting elements are indispensable, especially for professionally used mowers that are subjected to intensive use.

An illustration of the state of the art is given by documents

EP 2 589 284, FR 2 589 668 and U.S. Pat. No. 4,041,679. Document EP 2 589 284 shows in particular, a mower with a folding handlebar that can be stored in a vertical position.

### DISCLOSURE OF THE INVENTION

The purpose of the present invention is to propose a wheeled mower for a walk-behind operator, of simple and sturdy construction capable of being made particularly compact in view of its storage and transportation.

It is also the purpose of the invention to propose such a mower that is particularly shock-proof during cleaning, transportation or maintenance.

The invention also intends to propose such a mower that offers easy and safe access to the cutting elements.

To achieve these objectives, the invention proposes a mower including: a chassis, with a rear portion provided with wheels on a fixed axis of rotation and a front portion provided with at least one pivoting wheel, a cutting unit integrated with the chassis and a handlebar.

In conformance with the invention, the handlebar is mounted on at least one rigid extension of the rear portion of the chassis with a hinge along an axis parallel to the axis of rotation of the rear wheels, between at least one working position, high, and a maintenance position, low, in which the handlebar is folded back towards the front portion of the chassis, and the front portion of the chassis is provided with at least one lock to lock the handlebar in the maintenance position.

The so-called maintenance position of the handlebar does in effect facilitate cleaning and maintenance of the mower. This same position can also be kept to lift, manually move, store and transport the mower. In particular, the maintenance position can be maintained for the transportation of the mower in a utility vehicle. In this case, the chassis and the handlebar in the maintenance position constitute effective shock protection.

The lock may be a lock of any type suitable for retaining the handlebar. It may be a lock with a manual key pin or with an automatic catch. It may feature in particular spring-loaded maintenance hooks which engage an adapted portion of the handlebar. Preferably and for safety reasons, the release of the lock is done manually.

The handlebar, the chassis and its rear extension are preferably tubular structures made of steel or aluminum. They may notably be made of tubes with oblong cross-sections to enhance the rigidity of the chassis and the retention of the various mower components attached to the chassis. Incidentally, the tubular assembly constituting the chassis is preferably without any weldments. The same applies to the various elements which are mounted on the chassis, such as the cutting unit and the rear extension. The various portions of the chassis and the mounted elements may be held in place notably by fitting them together, by sleeve tubing or by screwed-on flanges. This makes for easy maintenance and replacement of each individual component of the mower.

The chassis extends itself essentially along a plane parallel to the ground surface when the front and rear wheels are in contact with the ground. The rigid extension, mounted preferably on lateral side rails of the chassis extends itself outside of the plane of the chassis, upwards, that is to say, away from the wheels. It serves for the attachment of the handlebar and for the stability of the mower when it is supported by the former in the maintenance position, for example for storage purposes. The rigid rear extension presents preferably a height between one and two thirds of the length of the chassis and also preferably a length between a third and half the length of the chassis.

The rigid extension presents itself for example in the form of a small straight bow which is attached to the side rails of the chassis.

According to a particular aspect of the invention, the hinge pin of the handlebar may be located in a plane essentially perpendicular to the chassis and passing between the axis of rotation of the rear wheels and a rear end of the mower.

This particular feature presents the advantage that the handlebar can be folded back over the mower, in alignment with the chassis so as to minimize the space it occupies.

The mower may feature at least one hinge along the axis of articulation of the handlebar, connecting the handlebar to the rear extension, the hinge being provided with a lock to block the handlebar in the high working position. Preferably two hinges are provided respectively on two arms of the handlebar to articulate it on both sides of a rear extension in the form of a small straight bow.

In the working position, the handlebar extends obliquely upwards and towards the rear of the chassis of the mower. Several working positions, so-called “high” as opposed to the maintenance position, may be provided to suit the height of the operator. The hinges may be provided to this effect with indexed notches for different height positions or may be equipped with a tightening device, to block the handlebar in a high position selected by the user.

According to a particular implementation of the mower, it may feature one or several support elements integrated in the handlebar or the rear extension, the support element being susceptible to come into contact with the ground when the mower is pivoted backwards, around its rear wheels.

Thus, the mower can occupy at least two positions relative to the ground surface. A first position corresponds to that for mowing, in which the mower is supported by its rear and front wheels and in which the chassis finds itself essentially parallel to the ground. In other words, this is a position where the chassis of the mower is essentially horizontal as long as the mower is placed on horizontal ground or a horizontal support.

A second stable position of the mower can be occupied when the handlebar is in the maintenance position, that is to say, folded up towards the front of the chassis. Then the support occurs on the rear wheels and the support element. The mower can be put into this position by pivoting it towards the back around its rear wheels. It can be seized for this purpose by the handlebar in the maintenance position. As a matter of fact, in its folded position the handlebar is locked on the front portion of the chassis and thus constitutes with the chassis a particularly rigid structure allowing easy handling of the mower. To place the mower in this position it is useful to remove, if applicable, a collecting bin for mowed plant clippings, if the mower is equipped with one.

The chassis of the mower is then in an essentially perpendicular position to the ground or slightly inclined, so that the location of the center of gravity of the mower contributes to the stability of the position.

The support element may be constituted for example by the arm ends of the handlebar, it may also be formed by a horizontal bar of a straight bow forming the rigid rear extension.

In the resting-on-the-support position access to the cutting unit and in particular to the blades and the casing of the cutting unit is greatly facilitated. This position is therefore useful for cleaning and maintenance operations.

According to a preferred implementation of the mower of the invention, the rigid rear extension and the end of the handlebar in the maintenance position may present an average height greater than a height of the cutting unit measured relative to the chassis so that the handlebar is maintained above an uppermost portion of the cutting unit in the maintenance position.

The term height is to be understood as relative to the chassis when the mower is placed on the ground, supported by its wheels.

Thus, in the maintenance position, the handlebar and in particular the arms of the handlebar constitute a protective fitting of the uppermost portion of the cutting unit which is to say the portion opposite that of the cutting blade.

It is also feasible to have the mower occupy a third position in which it is turned upside down and rests entirely on the handlebar in its maintenance position. The housing and the cutting blade, as well as the wheels are then turned upward and especially accessible for a maintenance operation. The cutting unit remains in this case isolated from the ground and does not rest on it, as long as, it is flat, taking into account the position of the handlebar above it in the maintenance position.

According to an especially simple and stable implementation of the handlebar, it may present two articulated arms on the rigid rear extension which are interconnected by a crossbar section. The crossbar section may be provided with grips for its manipulation by an operator. It is to be noted that the handlebar may be shaped differently and feature for example only a single central hinged post on the rear extension of the chassis. The free end of the handlebar, or the crossbar section forming the free end, may be configured so as to cooperate with the lock positioned at the front of the chassis when the handlebar is folded back in the maintenance position.

The motorized cutting unit of the mower may include a motor [or engine], a cutter casing and one or several cutting blades housed inside the casing and capable of being driven in rotation by the motor. The casing is preferably mounted on the chassis with a possibility to adjust the height, in order to adjust the mowing height. Especially the cutter casing containing the blades may be suspended from the chassis by a fixture in the shape of a parallelogram for the adjustment of its height. The motor may be at a fixed position on the chassis or, preferably, integrated into the cutter casing.

The mower may be of the push or self-propelled type. When it is self-propelled it may also include a back-geared assembly coupling the motor of the cutting unit to the rear wheels.

Alternatively, and especially in the case of an electric mower, each rear wheel may also be provided with its own electric drive motor and a back-geared assembly.

The motor of the cutting unit may also be an electric motor. Its power supply may be provided through an electric cable connected to the power grid. However, and preferably, the mower may feature at least one storage battery for its energy supply. The battery may be integrated into the cutter casing, or preferably, may be attached directly to the chassis.

In particular, the battery may serve to supply the motor of the cutting unit and possibly one or several motors used for the propulsion of the mower, if applicable.

Other characteristics and advantages of the invention become clear from the following description of the figures. This description is given for illustration purposes and not meant to be limiting.

### SHORT DESCRIPTION OF THE FIGURES

FIG. 1 is a perspective view of a mower according to the invention, with a handlebar in working position and of an operator of this mower.

FIG. 2 is an exploded perspective view showing the elements of the mower of FIG. 1, with the components of the cutting unit not being shown.

FIG. 3 is a perspective view of the mower of FIG. 1 with the handlebar in maintenance position.

FIG. 4 is a side view of the mower of FIG. 3, while resting on its wheels.

FIG. 5 is a side view of the mower of FIG. 3 in a pivoted position.

FIG. 6 is a partial view of a detail at a larger scale, of the mower of FIGS. 1, 3, 4, and 5, illustrating the locking of the handlebar in a maintenance position.

### DETAILED DESCRIPTION OF THE OPERATING MODES OF THE INVENTION

In the following description, with reference to the figures of the drawings, identical or similar parts are identified with the same reference marks so that one can refer back from one figure to the other.

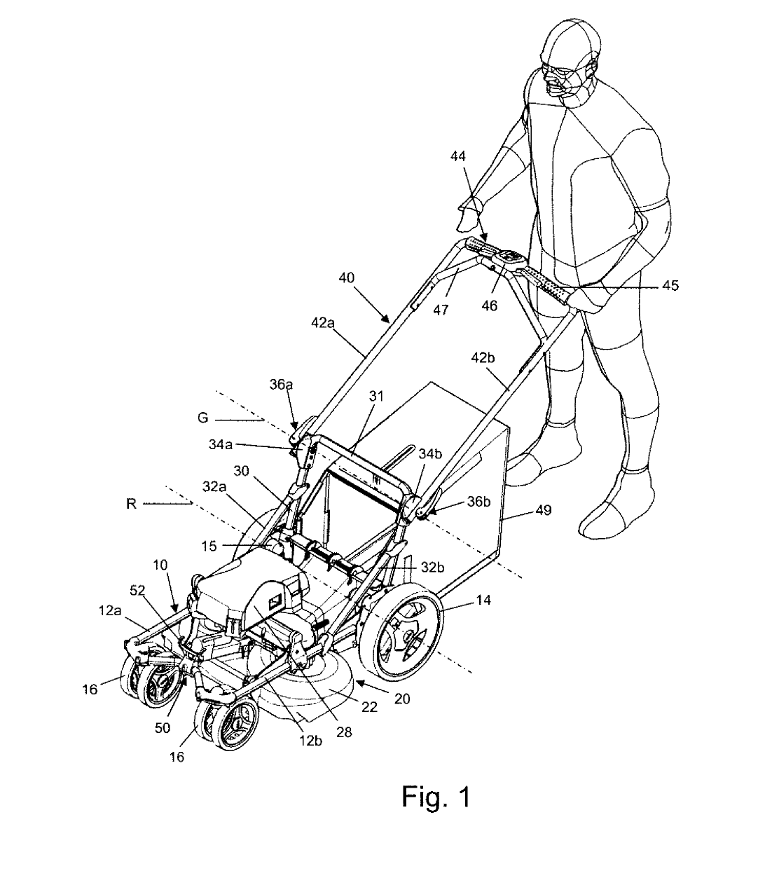

FIG. 1 shows a mower according to the invention.

It includes a chassis 10 of tubing with an oblong cross-section. Tube with oblong cross-section means a tube the cross-section of which is similar to an oval or an ellipse or to a cross-section within a parallelepiped with one or more sides of this cross-section having a rounded shape. The chassis 10 includes two tubular side rails 12a, 12b and extends essentially in one plane.

A rear portion of the chassis carries two rear wheels 14 which, in the example shown, are driving wheels each equipped with a drive motor 15 mounted on a reduction gear. Two loose wheels 16 are mounted in the front portion of the chassis which are capable of swiveling at 360° around an essentially vertical axis in the operating position of the mower. The swivel pin of the front wheels is essentially perpendicular to their axis of rotation. The front wheels 16 are here double wheels. The terms front and rear are to be understood to mean in relation to the normal forward movement of the mower and in relation to the position of the operator of the mower who walks behind the mower during the mowing operation.

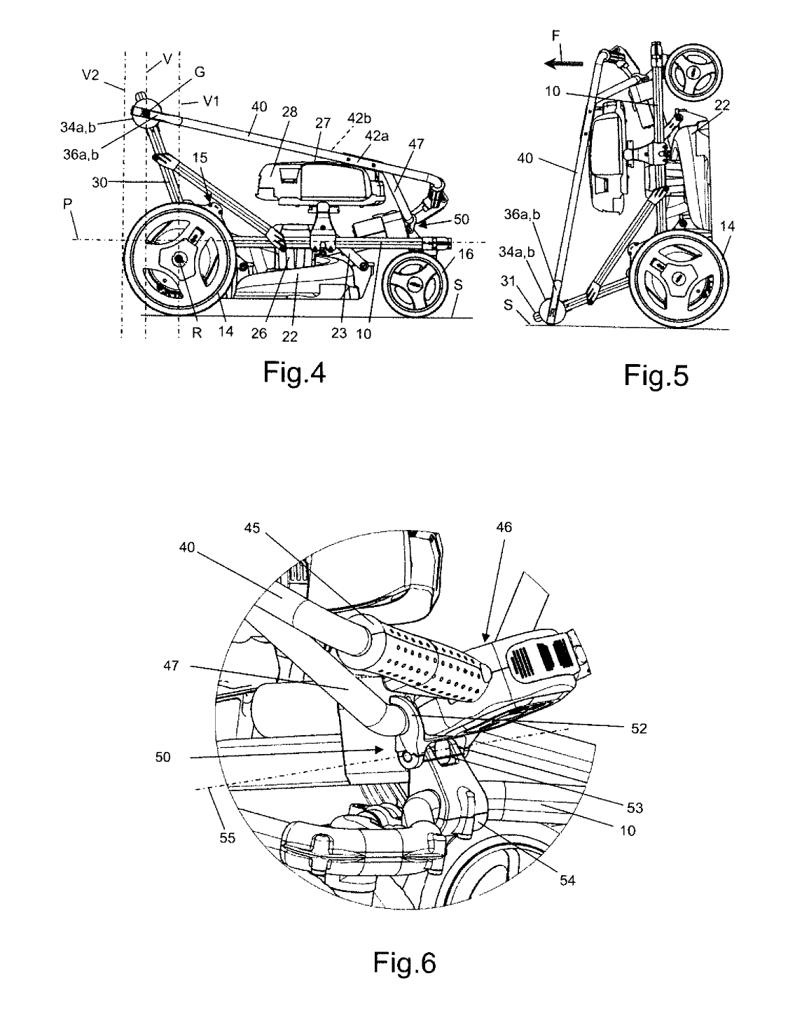

On the chassis 10 is attached a cutting unit 20 provided with a cutter casing 22 housing cutting blades that are not shown on the figures as they are placed under the cutter casing, and with an electric motor 26. The motor 26 is mounted directly on the cutter casing. The cutting unit 20 also features a battery 28 for the supply of electric current to the motor mounted directly on the chassis. The battery, according to one variant, may be integrated into the cutter casing. In the example shown, the cutter casing 22 is mounted on the chassis with the capability of adjusting its height. In particular the cutter casing is suspended in the chassis by rocker bars of a parallelogram suspension. A portion of this parallelogram suspension is indicated with the reference 23 on FIG. 4 described further down.

As an alternative, it may also be designed for adjusting the cutting height of the mower by acting on the height of the wheels, the cutter casing now being mounted rigidly on the chassis.

At the rear of the chassis 10 is visible a fixed and rigid extension 30 protruding upward, that is to say opposite of the surface the wheels rest on when the mower is in the mowing position. In the example shown the rear extension includes a tubular straight bow 31 forming a bridge between the side rails 12a and 12b of the chassis. The straight bow is fastened on each side, respectively on the side rails 12a and 12b of the chassis and is held up by jambs 32a, 32b which also rest on the side rails 12a, 12b. The preferably tubular jambs firmly maintain the position of the straight bow 31. The free portion of the extension, that is to say, the high part of the bow is provided on each side with a hinge 34a, 34b on which a handlebar 40 is connected. The handlebar includes arms 42a, 42b fastened respectively to the hinges 34a, 34b. The hinges 34a, 34b allow pivoting the handlebar 40 along an axis of articulation G parallel to the axis of rotation R of the wheels and perpendicular to the side rails 12a, 12b of the chassis 10, so that the handlebar can be folded over the mower and towards the front.

The handlebar presents a crossbar section 44 essentially perpendicular to the arms 42a, 42b and parallel to the uppermost portion of the straight bow 31.

The crossbar section 44 is provided with holding handles 45 and a mower control unit 46. A second reinforcing crossbar 47 is provided in the example shown. The control unit is electrically connected to the motor so as to control, for example, the forward speed of the mower.

The height of the working position of the handlebar can be adjusted by varying the angle between the arms of the handlebar and the fixed rear extension, that is to say the opening of the hinges 34a, 34b. To maintain the desired and user-adapted working position the hinges are provided with tightening cams 36a, 36b to block the high position of the handlebar.

In the example of implementation of the mower illustrated in FIG. 1, a collection bag 49 for the collection of the plant clippings can be seen. This is a removable collection bag which can be withdrawn when the mower is in a backward-pivoted position as shown in FIG. 5, described below. The removable collection bag is not shown on the following figures.

It must be specified that a mower according to the invention may or may not be provided with a removable collection bag for the recovery of the clippings. In particular the mower can also be configured for mulching, without the bag.

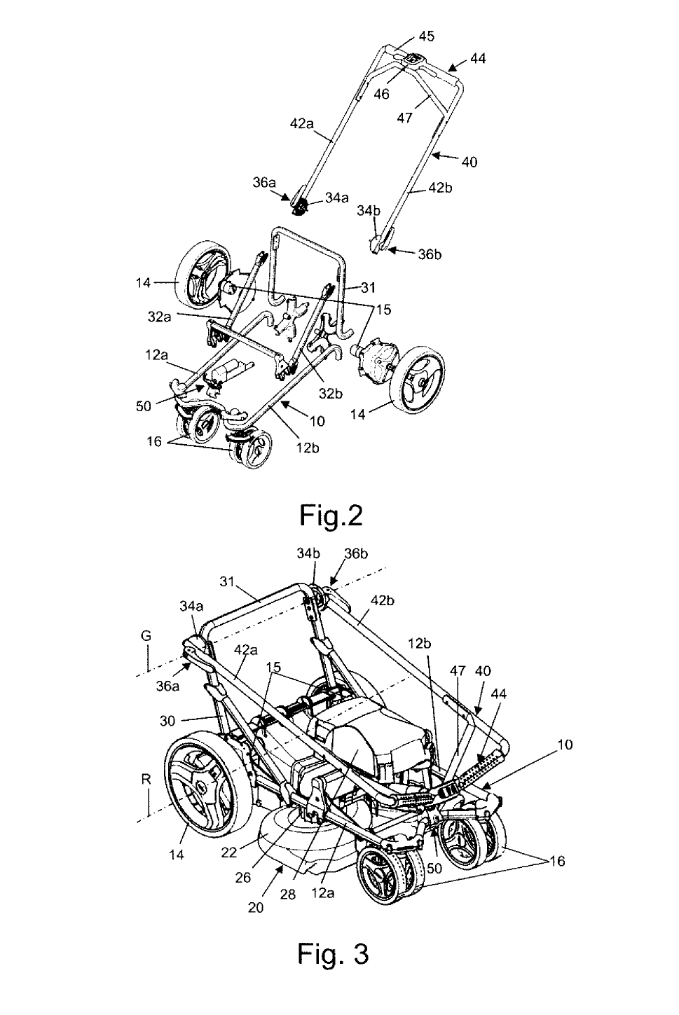

FIG. 2 shows the components of the mower shown in FIG. 1. It shows in particular, the tubular elements forming the chassis, the rear extension and a certain number of components added on the chassis, such as the handlebar, the wheels or an attachment of the cutting unit. The cutting unit as such is not shown. The assembly of the chassis components and the attachment of the added components is done by means of sleeves and screwed-on flanges. This is an assembly without weldments.

FIG. 3 shows the mower of FIG. 1 with the handlebar in the maintenance position. The tightening cams 36a, 36b are loosened and the handlebar 40 is pivoted forward above the mower around the axis of articulation G. One can see that the length of the handlebar, that is to say, essentially the length of its arms 42a, 42b in the example of implementation shown, is essentially equal to the length of the chassis. Thus, in the folded-back maintenance position, the crossbar section 44 which constitutes the free end of the handlebar is rejoining the front of the chassis where a lock 50 of the handlebar is located. Preferably the length of the handlebar is such that the crossbar section 44 remains drawn back from the front end of the chassis so as to be protected from shocks during unexpected movements of the mower, for example when it is put on the bed of a truck during its transportation.

In the example shown, and as is better shown in FIG. 6, the lock 50 includes hooks 52 pivoting around an axis 55 and loaded by a torsion spring 53 which engages on a portion of the handlebar 40. More precisely, and as shown on FIG. 6, the hooks engage the reinforcement crossbar 47. The lock 50 is fixed on the chassis 10 by a screwed flange 54. When the hooks 52 are engaged on the reinforcing crossbar 47, a mechanical locking device works to ensure a connection between the handlebar and the chassis. It is thus possible to manipulate the mower directly with the handlebar without having to lock the tightening cams 36a and 36b. In the example shown, the unlocking of the handlebar requires a manual action on the hooks 52 in the forward direction of the mower, in order to release it [i.e. the handlebar]. The handlebar can then be pivoted into its working position.

FIG. 4 is a side view of the mower of FIG. 3 resting on horizontal ground S with its front and rear wheels 14, 16.

It is shown that the axis of articulation G of the hinges 36a, 36b of the handlebar 40 around the upper end of the fixed rear extension 30 of the chassis 10 is located above the plane P along which the chassis and in particular the side rails are extended. More precisely, the axis of articulation G is situated in a vertical so-called reference plane V, perpendicular to the plane P of the chassis, and preferably positioned between a first plane V1 parallel to the reference plane V and including the axis of rotation R of the rear wheels and a second plane V2 parallel to the reference plane V, passing through the rear overall end of the mower. In the example shown, the rear overall end of the mower is formed by the tire tread of the rear wheels 14.

It is shown that the height of the rear extension 30 is considered to be the height of the axis of articulation G around which the handlebar turns, relative to plane P of the chassis, and the height of the lock 50 which receives the end of the handlebar are such that their average is greater than the height of the uppermost part 27 of the cutting unit so that the handlebar is maintained above an uppermost portion of the cutting unit in the maintenance position. In the example shown the uppermost portion 27 corresponds to the battery 28 of stored electrical energy.

Thus the handlebar 40, and in particular its arms 42a and 42b protect, in their maintenance position, the uppermost portion 27 of the cutting unit, and in particular the battery 28.

FIG. 5 shows the mower of FIG. 3 pivoted towards the rear, in the direction of an arrow F, around the rear wheels 14. In this position the mower rests on its rear wheels 14 and a support element which is formed in the example of the figure by an extension of the hinges. According to other possibilities of implementation the support element may also be formed by the end of the arms of the handlebar or by the top of the straight bow 31 forming the rigid rear extension 30. Possibly a specific bearing pad may be provided.

The locked handlebar in the maintenance position forms, together with the chassis, an especially rigid structure which ensures the stability of the mower and the protection of its components. Incidentally, the position of the mower shown in FIG. 5 facilitates access to the cutting casing 22 and to the cutting blades located inside.

It is to be noted that in this position the blocking of the hinges by means of the tightening cams 36a, 36b is not indispensable, the handlebar being kept in place by the lock 50.

1. Mower on wheels including:
a chassis with a rear portion provided with rear wheels with a fixed axis of rotation and a front portion provided with at least one swiveling wheel,
a motorized cutting unit integrated in the chassis, and
a handlebar,
characterized in that the handlebar is mounted on at least one rigid rear extension of the rear portion of the chassis with an articulation along an axis of articulation (G) parallel to the axis of rotation (R) of the rear wheels, between at least one so-called working position and a so-called maintenance position, in which the handlebar is folded back towards the front portion of the chassis, and the front portion of the chassis including a lock to block the handlebar in said maintenance position.

2. Mower according to claim 1, wherein the chassis is a chassis made of tubular components.

3. Mower according to claim 1, wherein the chassis features tubular chassis components with an oblong cross-section.

4. Mower according to claim 2, wherein the tubular chassis components are assembled without weldments, and including components associated with the chassis, attached to the chassis without weldment.

5. Mower according to claim 1, wherein the axis of articulation (G) is located in a reference plane (V) essentially perpendicular to a plane (P) of the chassis, the reference plane (V) being situated between a first plane (V1) parallel to the reference plane (V) and including the axis of rotation (R) of the rear wheels, and a second plane (V2) parallel to the reference plane (V) and passing through an overall rear end of the mower.

6. Mower according to claim 1, further comprising at least one hinge along the pivot axis of the handlebar, connecting the handlebar to the rear extension of the chassis, the hinge being provided with a lock to lock the hinge in the high working condition.

7. Mower according to claim 1, further comprising at least one support element integrated in the handlebar or the rear extension, the support element being capable of coming into contact with the ground when the mower is pivoted backwards, around its rear wheels, or turned upside down.

8. Mower according to claim 1, wherein the rigid rear extension and the end of the handlebar in the maintenance position present an average height that is greater than a height of the cutting unit, measured in relation to the chassis, so that the handlebar is maintained above an uppermost portion of the cutting unit in the maintenance position.

9. Mower according to claim 1, wherein the handlebar presents two arms articulated on the rigid rear extension, and interconnected by a cross-bar section.

10. Mower according to claim 1, wherein the motorized cutting unit includes a motor, a height-adjustable cutter casing, and at least one cutting blade (24) driven in rotation by the motor.

11. Mower according to claim 9, wherein the motor is an electric motor, the mower including furthermore at least one accumulator battery for the electric power supply of the motor.

12. Self-propelled mower according to claim 1, wherein each rear wheel is provided with an electric drive motor.
